(19) United States
(12) Patent Application Publication
(10) Pub. No.: US 2022/0378011 A1
(43) Pub. Date: Dec. 1, 2022

(54) COVER FOR ANIMAL CONTAINMENT ASSEMBLY

(71) Applicant: Diggs Inc., Long Island City, NY (US)

(72) Inventors: Zel Alexander CRAMPTON, Long Island City, NY (US); Jacqueline PREHOGAN, Toronto (CA); Isaac LANGLEBEN, Toronto (CA); Benjamin J. BECK, Boston, MA (US); Michael T. MCDUFFEE, Malden, MA (US); Ryan J. DONOVAN, Newton, MA (US); Douglas A. MARSDEN, Marblehead, MA (US); Courtney ARMSTRONG, Astoria, NY (US)

(21) Appl. No.: 17/776,535

(22) PCT Filed: Nov. 13, 2020
(86) PCT No.: PCT/US20/60439

§ 371 Date: May 12, 2022

Related U.S. Application Data
(60) Provisional application No. 62/934,847, filed on Nov. 13, 2019.

(51) Int. Cl. A01K 1/02; A01K 1/035

(52) U.S. Cl. CPC A01K 1/0245; A01K 1/0356

(57) ABSTRACT

Described herein is a covering system for an animal containment system. Specifically, described herein is an opaque panel bearing an attachment system and a removal system for deployment and removal from an animal crate. Further described herein is a plurality of panels providing a covering system to completely cover an animal crate to allow the animal to sleep, to quiet the animal, or to provide a sense of security to the animal.

### TECHNICAL FIELD

The present disclosure relates to the pet industry generally and more specifically to pet crates.

### BACKGROUND

Animal enclosures or crates for pets often include a mesh, portals, caging, or other assembly that allows light to propagate through the crate. Occasionally, it is desirable to cover the crate to allow the animal to sleep, to quiet the animal, to provide a sense of security to the animal, to provide an aesthetic aspect (e.g., to customize the appearance of the crate), or any other reason. Thus, it can be desirable to produce a cover for the crate that is substantially opaque, safe for the animal, easy to install and remove, easy to clean, hypoallergenic, and aesthetically pleasing.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to certain embodiments of the present invention, disclosed herein is a system for covering a crate assembly, comprising: at least one panel configured to cover a mesh network suspended by a support frame of the crate assembly; and an attachment system configured to hold the panel on the crate assembly covering the mesh network, wherein the panel blocks light transmission through the mesh network. In some cases, the at least one panel is configured to match a shape of the mesh network suspended by the support frame of the crate assembly. In some examples, the at least one panel comprises a panel substrate and a panel cover. In certain embodiments the panel substrate comprises a polymer, a metal, a composite, wood, a ceramic, or any combination thereof, and the panel cover comprises a synthetic fabric, a natural fabric, a polymer wrap, a polymer coating, a metal wrap, a veneer, a laminate, or any combination thereof. In some examples, the panel comprises a crate-facing side and an outward-facing side opposite the crate-facing side. In some cases, the panel has a thickness of from about 1 millimeter (mm) to about 15 mm. In certain embodiments, the panel cover is configured to cover the outward-facing side and wrap around at least one edge of the panel and at least partially cover the crate-facing side (e.g., the panel cover is configured to cover the outward-facing side and wrap around every edge of the panel and at least partially cover the crate-facing side). In certain embodiments, the system for covering a crate assembly further comprises a plurality of panels configured to cover a plurality of mesh networks suspended by the support frame of the crate assembly. In some cases, the plurality of panels is configured to cover the crate assembly in a desired configuration, wherein any panel of the plurality of panels is used individually or any panel of the plurality of panels in concert with at least a second panel of the plurality of panels. In certain aspects, the system for covering the crate assembly is configured to at least partially cover the crate assembly.

In some embodiments, the attachment system configured to hold the panel on the crate assembly covering the mesh network comprises a magnet, a hook, a hook and loop system, a snap, a button, a latch, a clasp, or any combination thereof. In some examples, the attachment system configured to hold the panel on the crate assembly covering the mesh network comprises a pull strength of at least about 1 pound (lb), or up to about 7.2 lb. In certain aspects, the attachment system configured to hold the panel on the crate assembly covering the mesh network is positioned on the crate-facing side of the panel (e.g., between the panel substrate and the panel cover).

Additionally, the system for covering the crate assembly further comprises a panel removal system. In some embodiments, the panel removal system comprises a pull loop, a handle, an indentation, a closeable opening, or any combination thereof, and the panel removal system is positioned on the outward-facing side of the panel. In some aspects, the panel removal system is configured to dislodge the panel from the crate assembly when activated (e.g., the panel removal system is configured to overcome the pull strength of the attachment system configured to hold the panel on the crate assembly covering the mesh network when activated). In some non-limiting examples, the system for covering the crate assembly further comprises at least one access port providing access to a crate assembly functionality (e.g., a door opening mechanism, a door latching mechanism, a door handle, a crate handle, a crate collapsing mechanism, a crate deploying mechanism, a feeding port, a food container, a watering port, a water bottle, or any combination thereof).

### BRIEF DESCRIPTION OF THE DRAWINGS

The specification makes reference to the following appended figures, in which use of like reference numerals in different figures is intended to illustrate like or analogous components.

FIG. 1 is a side top perspective view of a crate assembly with a deployed covering system according to certain aspects of the present disclosure.

FIG. 2 is a side top perspective view of a crate assembly showing the covering system exploded from the crate according to certain aspects of the present disclosure.

FIG. 3 is a top view of a top panel assembly of the covering system according to certain aspects of the present disclosure.

FIG. 4 is a top view of the top panel assembly of the covering system deployed onto the crate assembly according to certain aspects of the present disclosure.

FIG. 5 is a front top perspective view of the top panel assembly of the covering system deployed onto the crate assembly in a closed position according to certain aspects of the present disclosure.

FIG. 6 is a front top perspective view of the top panel assembly of the covering system deployed onto the crate assembly in an open position according to certain aspects of the present disclosure.

FIG. 7 is a bottom view of a top panel assembly of the covering system showing a crate-facing side of the top panel assembly according to certain aspects of the present disclosure.

FIG. 8 is a schematic showing a cross-section of a portion of the top panel assembly depicting an attachment system according to certain aspects of the present disclosure.

FIG. 9 is a front view of a door panel assembly of the covering system according to certain aspects of the present disclosure.

FIG. 10 is a front view of a door panel assembly of the covering system deployed onto the crate assembly according to certain aspects of the present disclosure.

FIG. 11 is a rear view of a door panel assembly of the covering system showing a crate-facing side of the door panel assembly according to certain aspects of the present disclosure.

FIG. 12 is a front view of an end panel assembly of the covering system according to certain aspects of the present disclosure.

FIG. 13 is a front view of an end panel assembly of the covering system deployed onto the crate assembly according to certain aspects of the present disclosure.

FIG. 14 is a rear view of an end panel assembly of the covering system showing a crate-facing side of the end panel assembly according to certain aspects of the present disclosure.

FIG. 15 is a front view of a side panel assembly of the covering system according to certain aspects of the present disclosure.

FIG. 16 is a front view of a side panel assembly of the covering system deployed onto the crate assembly according to certain aspects of the present disclosure.

FIG. 17 is a rear view of a side panel assembly of the covering system showing a crate-facing side of the side panel assembly according to certain aspects of the present disclosure.

### DETAILED DESCRIPTION

Certain aspects and features of the present disclosure relate to pet containment. The embodiments of the present disclosure described below are not intended to be exhaustive or to limit the disclosure to the precise forms described herein. Rather, the embodiments described herein are chosen so that a person of skill in the art can appreciate and understand the principles and practices of the present disclosure.

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” or “the” includes singular and plural references unless the context clearly dictates otherwise.

All ranges disclosed herein are to be understood to encompass both endpoints and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

As used herein, directional and spatial terms such as “horizontal,” “vertical,” “horizontally,” “vertically,” “outward,” and “upward” are not intended to be binding terms.

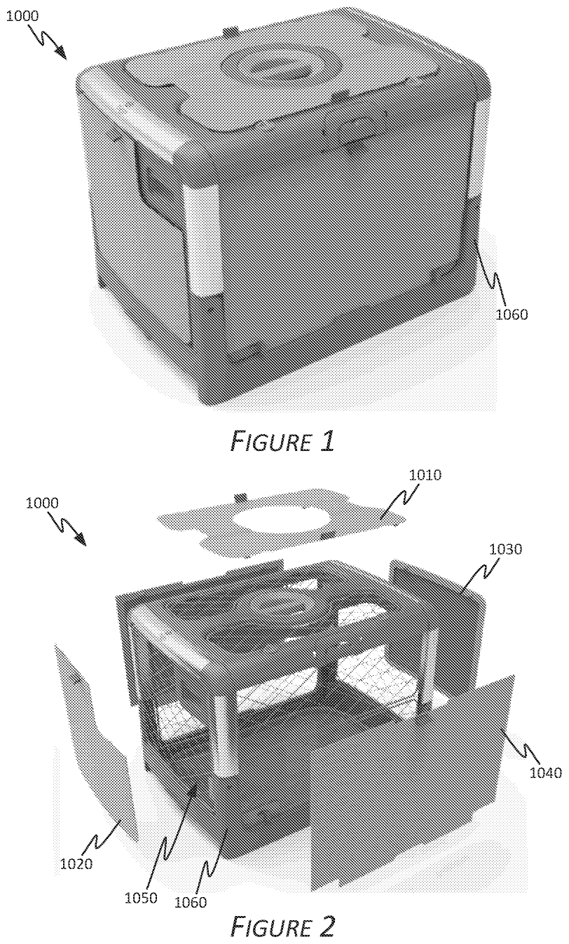

A representative embodiment is presented in FIG. 1. In some embodiments, a collapsible crate assembly 1000 as described in PCT Publication No. WO 2018/169693 A1, hereby incorporated by reference in its entirety, is covered by the covering system described here. The covering system can include, as in the example of FIG. 2, a top panel assembly 1010, a door panel assembly 1020, an end panel assembly 1030, and at least one side panel assembly 1040. In certain embodiments, the covering system described herein is configured to cover a mesh network 1050 of any suitable crate assembly. While a covering system designed to accompany the collapsible crate system described in the WO 2018/169693 publication is described throughout the text, the methods and articles apply to any animal containment system. In some examples, the animal containment system is a wire cage, a non-collapsible polymer crate, a travel crate, a decorative crate, a multifunctional crate, or the like.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

According to certain embodiments of the present invention, the covering system described herein includes at least one panel configured to cover the mesh network 1050 as shown in FIGS. 1 and 2. Accordingly, the mesh network 1050, as in the examples of FIGS. 1 and 2, is suspended within a support structure 1060 (e.g., a frame) of the crate assembly 1000. Thus, the covering system described herein is configured to cover the mesh network 1050 of the crate assembly 1000 and leave the support structure 1060 exposed, as shown in FIG. 1.

In some cases, the covering system described herein includes a plurality of panels to cover a plurality of mesh network 1050 areas defined by the support structure 1060 of the crate assembly 1000. For example, the covering system includes the top panel assembly 1010, the door panel assembly 1020, the end panel assembly 1030, and at least one side panel assembly 1040 (optionally, the covering system includes at least two of the side panel assembly 1040). Thus, in certain aspects, the covering system described herein can be at least partially deployed onto the crate assembly 1000. For example, the top panel assemble 1010 can be solely deployed onto the crate assembly 1000. In some cases, the door panel assembly 1020, the end panel assembly 1030, and at least one side panel assembly 1040, and optionally two side panel assemblies 1040, can be deployed onto the crate allowing light to propagate through the top of the crate assembly 1000. In a further example, the top panel assembly 1010 and at least one side panel assembly 1040, and optionally two side panel assemblies 1040 can be deployed onto the crate assembly 1000, for example, to alloy air flow through the crate assembly 1000. Accordingly, any combination of the plurality of panels can be deployed to provide any desired configuration.

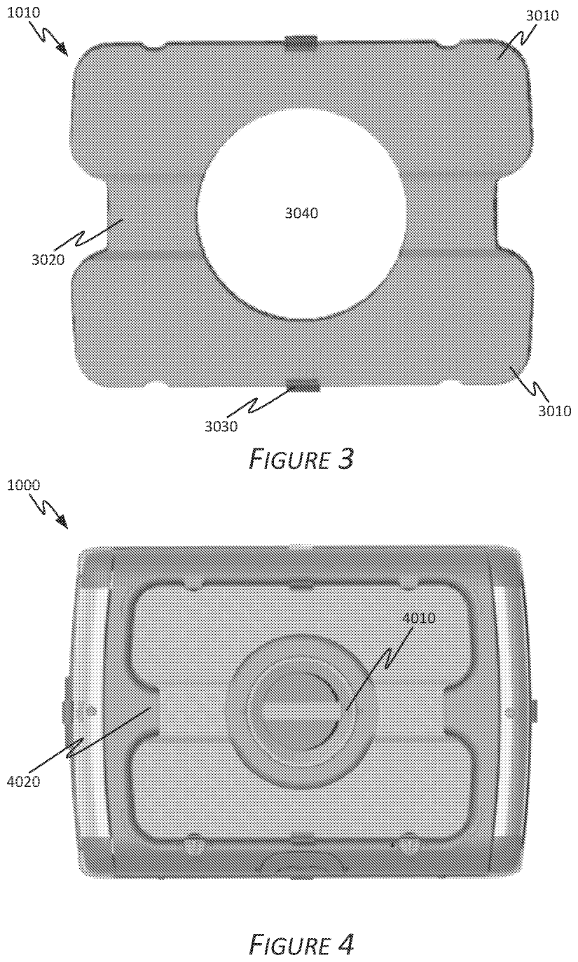

A representative top panel assembly 1010 is shown in FIGS. 3-7. In some embodiments, the top panel assembly 1010 is shaped to cover the mesh network 1050 and allow the use of functional aspects of, for example, the collapsible crate assembly described in the WO 2018/169693 A1 publication, though it need not. As described herein, the top panel assembly 1010 includes top cover panels 3010 to cover the mesh network 1050 of a top of the crate assembly 1000. In some examples, the top panel assembly 1010 includes a raised portion 3020 such that the top panel assembly 1010 can cover the mesh network 1050 and a cross member 4020 (see FIG. 4) of the top of the crate assembly 1000. In some embodiments, each panel of the covering system described herein includes a system for removing the panel from the crate assembly 1000 (i.e., a removal system). As described herein, the removal system is at least one pull loop 3030. Optionally, the removal system can be a handle, an indentation, a closeable opening, or any combination thereof. As shown in FIG. 3, the top panel assembly 1010 includes the at least one pull loop 3030 such that a user can remove the top panel assembly 1010 by grasping and pulling the pull loop 3030. The top panel assembly 1010 further includes, in the example of FIG. 3, an access port 3040 such that a user can access a handle 4010 as in the example of FIG. 4. FIG. 4 is a top view of the top panel assembly 1010 deployed onto to the crate assembly 1000. In certain embodiments, the access port 3040 can be configured to provide access to any suitable crate assembly functionality, for example, a door opening mechanism, a door latching mechanism, a door handle, a crate handle, a crate collapsing mechanism, a crate deploying mechanism, a feeding port, a food container, a watering port, a water bottle, or any combination thereof.

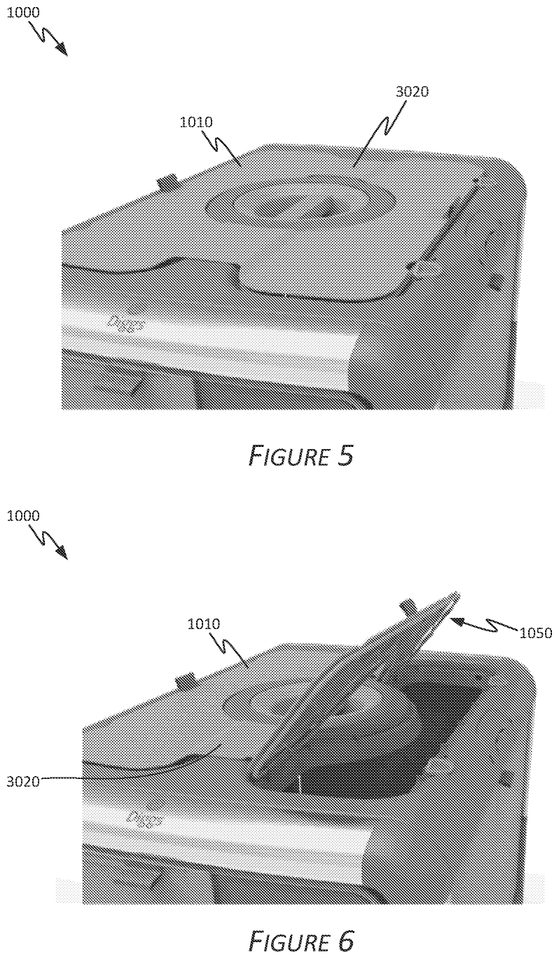

In some cases, the top panel assembly 1010 is a flexible panel such that at least a portion of the top of the crate assembly 1000 can be opened to access the interior of the crate assembly 1000. FIGS. 5 and 6 show the top panel assembly 1010 covering the mesh network 1050. The mesh network 1050 of the top of the crate assembly 1000 is an openable portion of the top of the crate assembly 1000 as described herein. FIG. 5 shows the top panel assembly 1010 covering the mesh network 1050 in a closed configuration. FIG. 6 shows the top panel assembly 1010 covering the mesh network 1050 in an open configuration. Accordingly, the raised portion 3020 is a flexible portion of the top panel assembly 1010 allowing a hinged mesh network 1050 to be opened and closed while covered by the top panel assembly 1010. In certain aspects, the raised portion 3020 is a fabric, a flexible polymer (e.g., a natural polymer, a synthetic polymer, or a combination thereof), a flexible composite, or any combination thereof. In certain examples, the fabric can be a weatherproof fabric (e.g., a fabric used to produce camping tents or the like). In some non-limiting examples, the raised portion 3020 is joined to the top cover panels 3010 by a hinge or any suitable pivoting connection system.

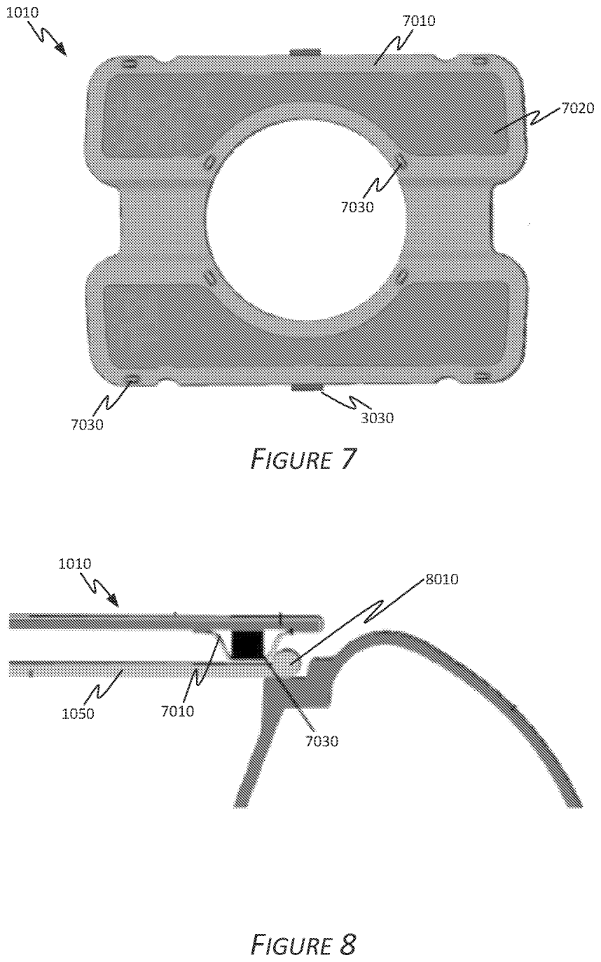

FIG. 7 shows the crate-facing side of the top panel assembly 1010. In some embodiments, the covering system described herein includes a panel cover 7010. In some cases, the panel cover 7010 is a synthetic fabric, a natural fabric, a polymer wrap, a polymer coating, a metal wrap, a veneer, a laminate, or any combination thereof. In some cases, the panel cover 7010 has a thickness of from about 0.1 mm to about 1 mm (e.g., from about 0.2 mm to about 0.9 mm, from about 0.3 mm to about 0.8 mm, from about 0.4 mm to about 0.7 mm, or from about 0.5 mm to about 0.6 mm). For example, the panel cover 7010 has a thickness of about 0.1 mm, about 0.2 mm, about 0.3 mm, about 0.4 mm, about 0.5 mm, about 0.6 mm, about 0.7 mm, about 0.8 mm, about 0.9 mm, or about 1 mm. In certain aspects, the panel cover 7010 covers the outward-facing side of, for example, the top panel assembly 1010, wraps around the edge of the top panel assembly 1010, and at least partially covers the crate-facing side of the top panel assembly 1010, as in the example of FIG. 7. In some examples, the panel cover 7010 is a removable panel cover 7010. For example, the panel cover 7010 can be removed for cleaning (e.g., rinsing, laundering, or the like). Additionally, the panel substrate can be cleaned when the removable panel cover 7010 is removed.

As shown in FIG. 7, the panel substrate 7020 is visible (e.g., only partially covered by the panel cover 7010). In certain examples, the panel substrate 7020 is a polymer, a metal, a composite, wood, a ceramic, or any combination thereof. For example, the polymer can be high density polyethylene (HDPE), polypropylene (PP), polystyrene (PS), poly(methyl methacrylate) (PMMA), a polyurethane (PU) foam, any suitable polymer, or any combination thereof. In certain cases, the panel substrate is a rigid material or a flexible material. For example, the panel substrate 7020 can be a rigid material such that at least one panel of the covering system described herein can be stored flat when not in use. Optionally, the panel substrate 7020 can be a flexible material such that at least one panel of the covering system described herein can be rolled for storage, though it need not be. In some cases, the panel substrate 7020 has a thickness from about 1 mm to about 5 mm (e.g., from about 1.5 mm to about 14.5 mm, from about 2 mm to about 14 mm, from about 2 mm to about 8 mm, from about 2 mm to about 10 mm, or from about 2.5 mm to about 13.5 mm). For example, the panel substrate 7020 has a thickness of about 1 mm, about 1.2 mm, about 1.3 mm, about 1.4 mm, about 1.5 mm, about 1.6 mm, about 1.7 mm, about 1.8 mm, about 1.9 mm, about 2 mm, about 2.1 mm, about 2.2 mm, about 2.3 mm, about 2.4 mm, about 2.5 mm, about 2.6 mm, about 2.7 mm, about 2.8 mm, about 2.9 mm, about 3 mm, about 3.1 mm, about 3.2 mm, about 3.3 mm, about 3.4 mm, about 3.5 mm, about 3.6 mm, about 3.7 mm, about 3.8 mm, about 3.9 mm, about 4 mm, about 4.1 mm, about 4.2 mm, about 4.3 mm, about 4.4 mm, about 4.5 mm, about 4.6 mm, about 4.7 mm, about 4.8 mm, about 4.9 mm, about 5 mm, about 5.1 mm, about 5.2 mm, about 5.3 mm, about 5.4 mm, about 5.5 mm, about 5.6 mm, about 5.7 mm, about 5.8 mm, about 5.9 mm, about 6 mm, about 6.1 mm, about 6.2 mm, about 6.3 mm, about 6.4 mm, about 6.5 mm, about 6.6 mm, about 6.7 mm, about 6.8 mm, about 6.9 mm, about 7 mm, about 7.1 mm, about 7.2 mm, about 7.3 mm, about 7.4 mm, about 7.5 mm, about 7.6 mm, about 7.7 mm, about 7.8 mm, about 7.9 mm, about 8 mm, about 8.1 mm, about 8.2 mm, about 8.3 mm, about 8.4 mm, about 8.5 mm, about 8.6 mm, about 8.7 mm, about 8.8 mm, about 8.9 mm, about 9 mm, about 9.1 mm, about 9.2 mm, about 9.3 mm, about 9.4 mm, about 9.5 mm, about 9.6 mm, about 9.7 mm, about 9.8 mm, about 9.9 mm, about 10 mm, about 10.1 mm, about 10.2 mm, about 10.3 mm, about 10.4 mm, about 10.5 mm, about 10.6 mm, about 10.7 mm, about 10.8 mm, about 10.9 mm, about 11 mm, about 11.1 mm, about 11.2 mm, about 11.3 mm, about 11.4 mm, about 11.5 mm, about 11.6 mm, about 11.7 mm, about 11.8 mm, about 11.9 mm, about 12 mm, about 12.1 mm, about 12.2 mm, about 12.3 mm, about 12.4 mm, about 12.5 mm, about 12.6 mm, about 12.7 mm, about 12.8 mm, about 12.9 mm, about 13 mm, about 13.1 mm, about 13.2 mm, about 13.3 mm, about 13.4 mm, about 13.5 mm, about 13.6 mm, about 13.7 mm, about 13.8 mm, about 13.9 mm, about 14 mm, about 14.1 mm, about 14.2 mm, about 14.3 mm, about 14.4 mm, about 14.5 mm, about 14.6 mm, about 14.7 mm, about 14.8 mm, about 14.9 mm, or about 15 mm.

In certain embodiments, the covering system described herein includes an attachment system configured to hold at least one panel of the covering system on the crate assembly 1000. As shown in FIG. 7, the attachment system can be, for example, a plurality of magnets 7030. Optionally, the attachment system can be at least a hook or a plurality of hooks, a hook and loop system, at least a snap or a plurality of snaps, at least a button or a plurality of buttons, at least a latch or a plurality of latches, at least a clasp or a plurality of clasps, any suitable attachment system, or any combination thereof. As described herein, each magnet in the plurality of magnets 7030 is positioned near the edge of, for example, the top panel assembly 1010. In some cases, the magnets 7030 are positioned such that, when at least one panel of the covering system is deployed onto the crate assembly 1000, the magnets 7030 are attracted to a metal frame 8010 supporting the nesh network 1050 (see FIG. 8). FIG. 8 is a cross-sectional view of a portion of the top of the crate assembly 1000 having the top panel assembly 1010 deployed thereon. As shown in FIG. 8, when in the closed configuration described above, the magnets 7030 are positioned near the edge of the top panel assembly 1010 and covered by the panel cover 7010. The magnets 7030 are attracted to the metal frame 8010 that supports the mesh network 1050. In some cases, each magnet in the plurality of magnets 7030 has a pull strength of from about 1 lb to about 7.2 lb (e.g., from about 1.5 lb to about 4.5 lb, from about 2 lb to about 4 lb, from about 2.5 lb to about 3.5 lb). As used herein, pull strength is an amount of force required to overcome the magnetic force attracting a magnet to a metal article. For example, each magnet in the plurality of magnets 7030 has a pull strength of about 1 lb, about 1.1 lb, about 1.2 lb, about 1.3 lb, about 1.4 lb, about 1.5 lb, about 1.6 lb, about 1.7 lb, about 1.8 lb, about 1.9 lb, about 2 lb, about 2.1 lb, about 2.2 lb, about 2.3 lb, about 2.4 lb, about 2.5 lb, about 2.6 lb, about 2.7 lb, about 2.8 lb, about 2.9 lb, about 3 lb, about 3.1 lb, about 3.2 lb, about 3.3 lb, about 3.4 lb, about 3.5 lb, about 3.6 lb, about 3.7 lb, about 3.8 lb, about 3.9 lb, about 4 lb, about 4.1 lb, about 4.2 lb, about 4.3 lb, about 4.4 lb, about 4.5 lb, about 4.6 lb, about 4.7 lb, about 4.8 lb, about 4.9 lb, about 5 lb, about 5.1 lb, about 5.2 lb, about 5.3 lb, about 5.4 lb, about 5.5 lb, about 5.6 lb, about 5.7 lb, about 5.8 lb, about 5.9 lb, about 6 lb, about 6.1 lb, about 6.2 lb, about 6.3 lb, about 6.4 lb, about 6.5 lb, about 6.6 lb, about 6.7 lb, about 6.8 lb, about 6.9 lb, about 7 lb, about 7.1 lb, or about 7.2 lb. Thus, a user can grasp the pull loop 3030 of any panel of the covering system described herein and dislodge the panel from the crate assembly 1000 by applying a force greater than the pull strength of each magnet in the plurality of magnets 7030.

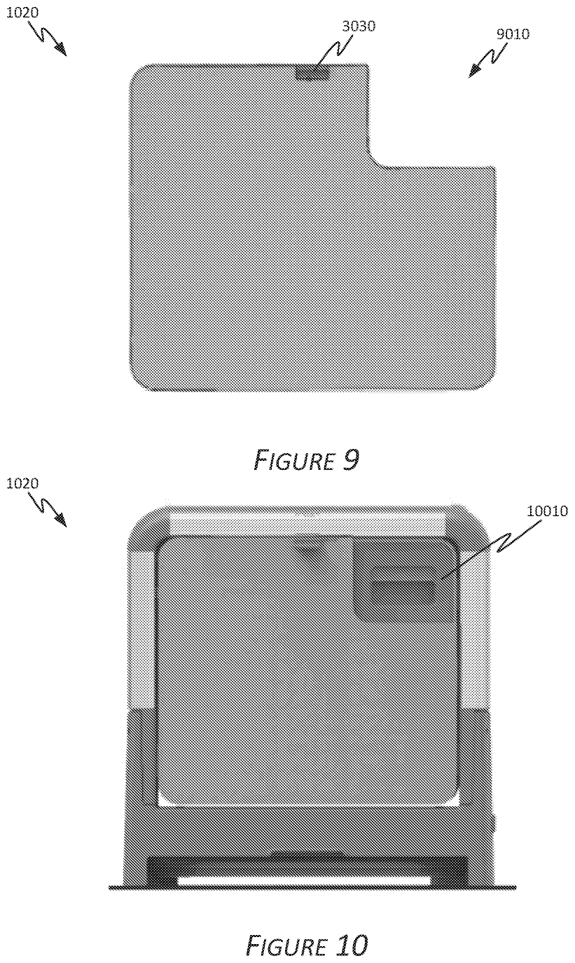

In certain embodiments, the covering system described herein includes a door panel assembly 1020 as shown in FIGS. 9-11. In some cases, the door panel assembly 1020 includes the pull loop 3030 described above positioned at a top edge of the door panel assembly 1020 as shown in FIG. 9. In some non-limiting examples, the door panel assembly 1020 includes an access portion 9010 such that a user can access, for example, a door handle 10010 of the crate assembly 1000 when the door panel assembly 1020 is deployed on a door of the crate assembly 1000, as in the example of FIG. 10. FIG. 11 shows the crate-facing side of the door panel assembly 1020. The panel cover 7010 partially covers the crate-facing side of the door panel assembly 1020. The panel substrate 7020 is visible on the crate facing side of the door panel assembly 1020. The plurality of magnets 7030 are positioned near the edges of the door panel assembly 1020 for attachment to the door of the crate assembly 1000.

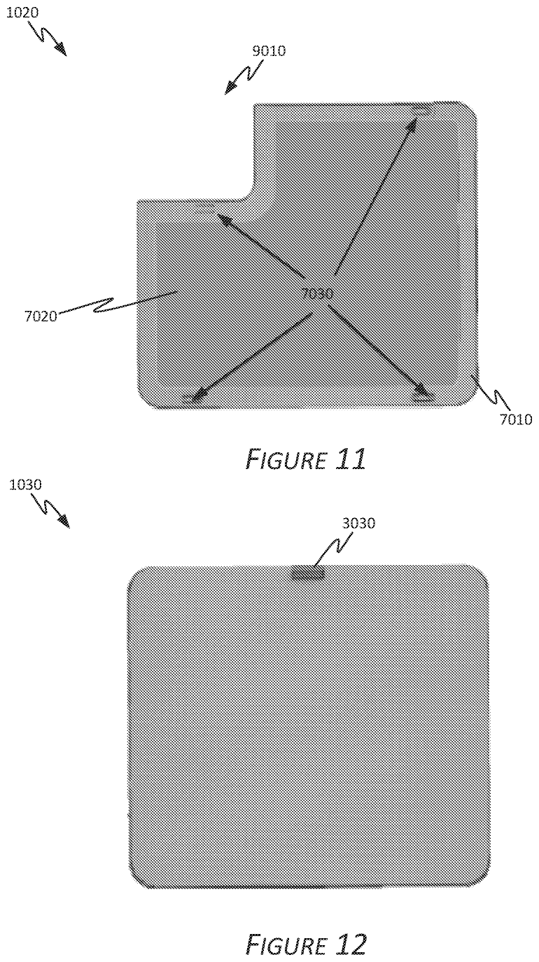

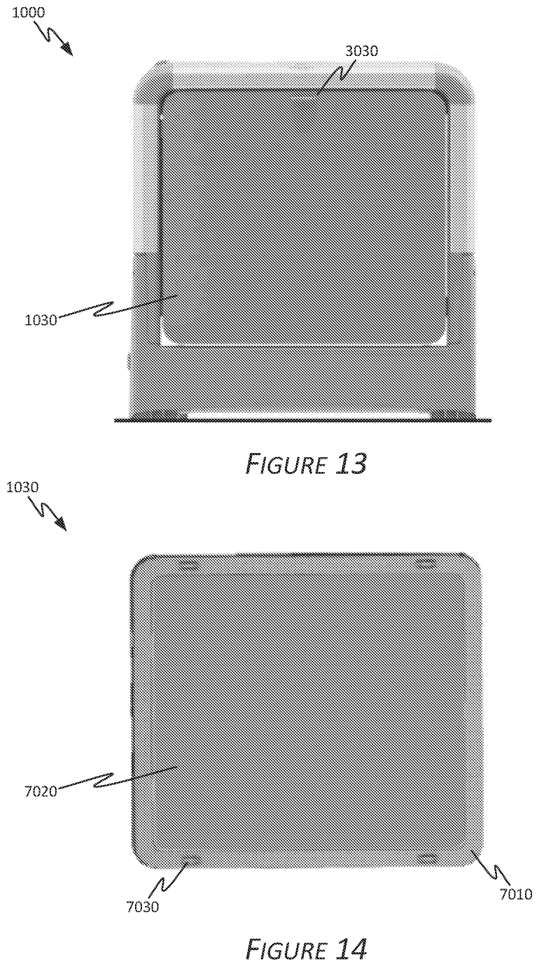

In certain embodiments, the covering system described herein includes an end panel assembly 1030 as shown in FIGS. 12-14. In some cases, the end panel assembly 1030 includes the pull loop 3030 described above positioned at a top edge of the door panel assembly 1030 as shown in FIG. 12. FIG. 13 shows the end panel assembly 1030 deployed onto an end of the crate assembly 1000. FIG. 14 shows the crate-facing side of the end panel assembly 1030. The panel cover 7010 partially covers the crate-facing side of the end panel assembly 1030. The panel substrate 7020 is visible on the crate facing side of the end panel assembly 1030. The plurality of magnets 7030 are positioned near the edges of the end panel assembly 1030 for attachment to the end of the crate assembly 1000.

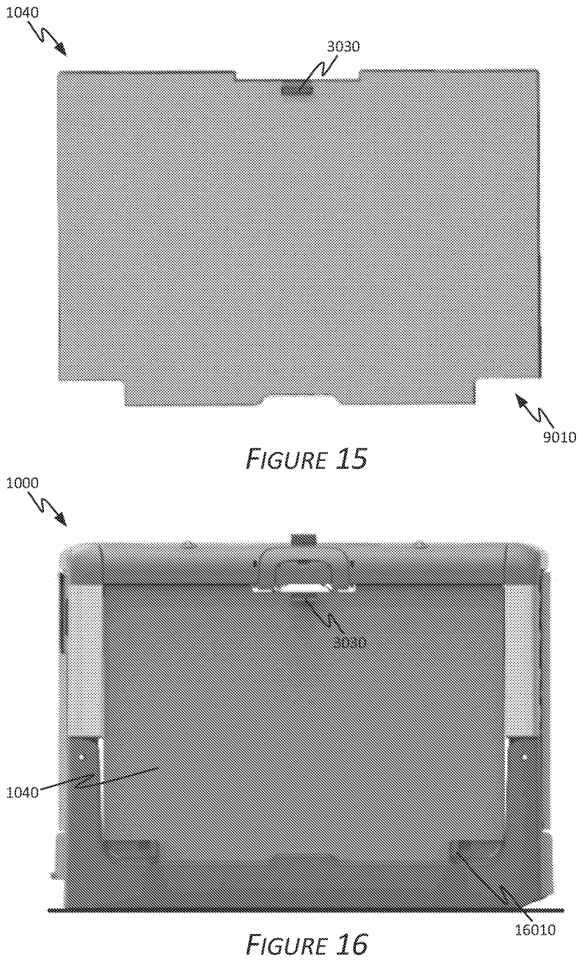

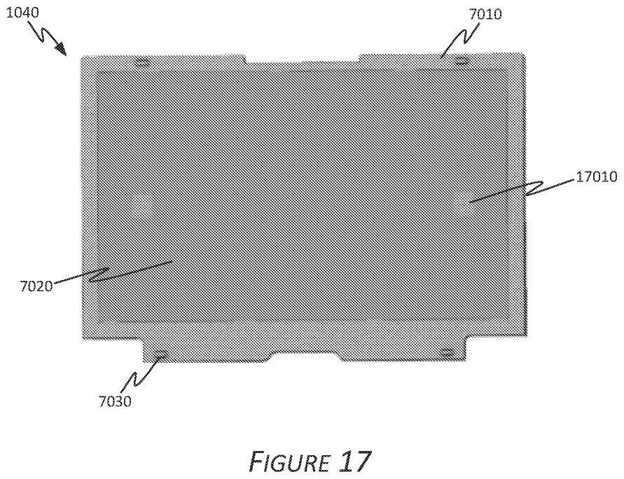

In certain embodiments, the covering system described herein includes at least one side panel assembly 1040 as shown in FIGS. 15-17. In some cases, the at least one side panel assembly 1040 includes the pull loop 3030 described above positioned at a top edge of the at least one side panel assembly 1040 as shown in FIG. 15. In certain aspects, the at least one side panel assembly 1040 includes the access portion 9010 such that a user can access, for example, a door latching mechanism 16010 of the crate assembly 1000 when the side panel assembly 1040 is deployed on, for example, an openable side of the crate assembly 1000, as in the example of FIG. 16. FIG. 16 shows the at least one side panel assembly 1040 deployed onto a side of the crate assembly 1000. FIG. 17 shows the crate-facing side of the at least one side panel assembly 1040. The panel cover 7010 partially covers the crate-facing side of the at least one side panel assembly 1040. The panel substrate 7020 is visible on the crate facing side of the at least one side panel assembly 1040. The plurality of magnets 7030 are positioned near the edges of the at least one side panel assembly 1040 for attachment to at least one side of the crate assembly 1000. Additionally, as described herein, the at least one side panel 1040 includes at least one cutout 17010 to allow clearance for a hinge positioned on an openable and/or collapsible side of the crate assembly 1000 as described in PCT Publication No. WO 2018/169693 A1. Thus, in the example of a collapsible crate assembly, the covering system described herein can remain at least partially deployed on the collapsible crate assembly when the collapsible crate assembly is collapsed.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

Illustration 1 is a system for covering a crate assembly, comprising: at least one panel configured to cover a mesh network suspended by a support frame of the crate assembly; and an attachment system configured to hold the panel on the crate assembly covering the mesh network, wherein the panel blocks light transmission through the mesh network.

Illustration 2 is the system for covering the crate assembly of any subsequent or preceding illustration, wherein the at least one panel is configured to match a shape of the mesh network suspended by the support frame of the crate assembly.

Illustration 3 is the system for covering the crate assembly of any subsequent or preceding illustration, wherein the at least one panel comprises a panel substrate and a panel cover.

Illustration 4 is the system for covering the crate assembly of any subsequent or preceding illustration, wherein the panel substrate comprises a polymer, a metal, a composite, wood, a ceramic, or any combination thereof.

Illustration 5 is the system for covering the crate assembly of any subsequent or preceding illustration, wherein the panel cover comprises a synthetic fabric, a natural fabric, a polymer wrap, a polymer coating, a metal wrap, a veneer, a laminate, or any combination thereof.

Illustration 6 is the system for covering the crate assembly of any subsequent or preceding illustration, wherein the panel comprises a crate-facing side and an outward-facing side opposite the crate-facing side.

Illustration 7 is the system for covering the crate assembly of any subsequent or preceding illustration, wherein the panel has a thickness of from about 1 millimeter to about 15 millimeters.

Illustration 8 is the system for covering the crate assembly of any subsequent or preceding illustration, wherein the panel cover is configured to cover the outward-facing side and wrap around at least one edge of the panel and at least partially cover the crate-facing side.

Illustration 9 is the system for covering the crate assembly of any subsequent or preceding illustration, wherein the panel cover is configured to cover the outward-facing side and wrap around every edge of the panel and at least partially cover the crate-facing side.

Illustration 10 is the system for covering the crate assembly of any subsequent or preceding illustration, further comprising a plurality of panels configured to cover a plurality of mesh networks suspended by the support frame of the crate assembly.

Illustration 11 is the system for covering the crate assembly of any subsequent or preceding illustration, wherein the plurality of panels is configured to cover the crate assembly in a desired configuration, wherein any panel of the plurality of panels is used individually or any panel of the plurality of panels in concert with at least a second panel of the plurality of panels.

Illustration 12 is the system for covering the crate assembly of any subsequent or preceding illustration, wherein the system for covering the crate assembly is configured to at least partially cover the crate assembly.

Illustration 13 is the system for covering the crate assembly of any subsequent or preceding illustration, wherein the attachment system configured to hold the panel on the crate assembly covering the mesh network comprises a magnet, a hook, a hook and loop system, a snap, a button, a latch, a clasp, or any combination thereof.

Illustration 14 is the system for covering the crate assembly of any subsequent or preceding illustration, wherein the attachment system configured to hold the panel on the crate assembly covering the mesh network comprises a pull strength of at least about 1 pound.

Illustration 15 is the system for covering the crate assembly of any subsequent or preceding illustration, wherein the attachment system configured to hold the panel on the crate assembly covering the mesh network comprises a pull strength of up to about 7.2 pounds.

Illustration 16 is the system for covering the crate assembly of any subsequent or preceding illustration, wherein the attachment system configured to hold the panel on the crate assembly covering the mesh network is positioned on the crate-facing side of the panel.

Illustration 17 is the system for covering the crate assembly of any subsequent or preceding illustration, wherein the attachment system configured to hold the panel on the crate assembly covering the mesh network is positioned between the panel substrate and the panel cover.

Illustration 18 is the system for covering the crate assembly of any subsequent or preceding illustration, further comprising a panel removal system.

Illustration 19 is the system for covering the crate assembly of any subsequent or preceding illustration, wherein the panel removal system comprises a pull loop, a handle, an indentation, a closeable opening, or any combination thereof.

Illustration 20 is the system for covering the crate assembly of any subsequent or preceding illustration, wherein the panel removal system is positioned on the outward-facing side of the panel.

Illustration 21 is the system for covering the crate assembly of any subsequent or preceding illustration, wherein the panel removal system is configured to dislodge the panel from the crate assembly when activated.

Illustration 22 is the system for covering the crate assembly of any subsequent or preceding illustration, wherein the panel removal system is configured to overcome the pull strength of the attachment system configured to hold the panel on the crate assembly covering the mesh network when activated.

Illustration 23 is the system for covering the crate assembly of any subsequent or preceding illustration, further comprising at least one access port providing access to a crate assembly functionality.

Illustration 24 is the system for covering the crate assembly of any subsequent or preceding illustration, wherein the crate assembly functionality comprises a door opening mechanism, a door latching mechanism, a door handle, a crate handle, a crate collapsing mechanism, a crate deploying mechanism, a feeding port, a food container, a watering port, a water bottle, or any combination thereof.

All patents, publications, and abstracts cited above are incorporated herein by reference in their entireties. Various embodiments of the invention have been described in fulfillment of the various objectives of the invention. It should be recognized that these embodiments are merely illustrative of the principles of the present invention. Numerous modifications and adaptions thereof will be readily apparent to those skilled in the art without departing from the spirit and scope of the present invention as defined in the following claims.

1. A system for covering a crate assembly, comprising:
at least one panel configured to cover a mesh network suspended by a support frame of the crate assembly; and
an attachment system configured to hold the panel on the crate assembly covering the mesh network, wherein the panel blocks light transmission through the mesh network.

2. The system for covering the crate assembly of claim 1, wherein the at least one panel is configured to match a shape of the mesh network suspended by the support frame of the crate assembly.

3. The system for covering the crate assembly of claim 1, wherein the at least one panel comprises a panel substrate and a panel cover.

4. The system for covering the crate assembly of claim 3, wherein the panel substrate comprises a polymer, a metal, a composite, wood, a ceramic, or any combination thereof and the panel cover comprises a synthetic fabric a natural fabric, a polymer wrap, a polymer coating, a metal wrap, a veneer, a laminate, or any combination thereof.

5. (canceled)

6. The system for covering the crate assembly of claim 1, wherein the panel comprises a crate-facing side and an outward-facing side opposite the crate-facing side.

7. The system for covering the crate assembly of claim 1, wherein the panel has a thickness of from about 1 millimeter to about 15 millimeters.

8. The system for covering the crate assembly of claim 1, wherein the panel cover is configured to cover the outward-facing side and wrap around at least one edge of the panel or every edge of the panel and at least partially cover the crate-facing side.

9. (canceled)

10. The system for covering the crate assembly of claim 1, further comprising a plurality of panels configured to cover a plurality of mesh networks suspended by the support frame of the crate assembly.

11. The system for covering the crate assembly of claim 10, wherein the plurality of panels is configured to cover the crate assembly in a desired configuration, wherein any panel of the plurality of panels is used individually or any panel of the plurality of panels in concert with at least a second panel of the plurality of panels.

12. The system for covering the crate assembly of claim 10, wherein the system for covering the crate assembly is configured to at least partially cover the crate assembly.

13. The system for covering the crate assembly of claim 1, wherein the attachment system configured to hold the panel on the crate assembly covering the mesh network comprises a magnet, a hook, a hook and loop system, a snap, a button, a latch, a clasp, or any combination thereof.

14. The system for covering the crate assembly of claim 13, wherein the attachment system configured to hold the panel on the crate assembly covering the mesh network comprises a pull strength of at least about 1 pound.

15. The system for covering the crate assembly of claim 13, wherein the attachment system configured to hold the panel on the crate assembly covering the mesh network a pull strength of up to about 7.2 pounds.

16. The system for covering the crate assembly of claim 1, wherein the attachment system configured to hold the panel on the crate assembly covering the mesh network is positioned on the crate-facing side of the panel or between the panel substrate and the panel cover.

17. (canceled)

18. The system for covering the crate assembly of claim 1, further comprising a panel removal system.

19. The system for covering the crate assembly of claim 18, wherein the panel removal system comprises a pull loop, a handle, an indentation, a closeable opening, or any combination thereof.

20. The system for covering the crate assembly of claim 18, wherein the panel removal system is positioned on the outward-facing side of the panel.

21. The system for covering the crate assembly of claim 13, wherein the panel removal system is configured to dislodge the panel from the crate assembly when activated.

22. The system for covering the crate assembly of claim 13, wherein the panel removal system is configured to overcome the pull strength of the attachment system configured to hold the panel on the crate assembly covering the mesh network when activated.

23. The system for covering the crate assembly of claim 1, further comprising at least one access port providing access to a crate assembly functionality, wherein the crate assembly functionality comprises a door opening mechanism, a door latching mechanism, a door handle, a crate handle, a crate collapsing mechanism, a crate deploying mechanism a feeding port, a food container, a watering port, a water bottle, or any combination thereof.

24. (canceled)
